(19) United States
(12) Patent Application Publication
(10) Pub. No.: US 2005/0066437 A1
(43) Pub. Date: Mar. 31, 2005

(54) Footbath with automatic sensing and switching

(76) Inventors: Martin A. Cohen, Ridgefield, CT (US); Vito James Carlucci, Stratford, CT (US)

Correspondence Address: STEVEN A. GARNER;CONAIR CORPORATION, ONE CUMMINGS POINT ROAD, STAMFORD, CT, 06902, US

(21) Appl. No.: 10/936,363

(22) Filed: Sep. 8, 2004

Related U.S. Application Data
(60) Provisional application No. 60/501,129, filed on Sep. 8, 2003.

(51) Int. Cl. E03C 1/00; A47K 3/022; A61H 35/00

(52) U.S. Cl. 4/622

(57) ABSTRACT

A footbath with an infrared sensor to detect the presence of a foot within the footbath. The footbath employs a sender to transmit an infrared signal and a sensor to receive the infrared signal. When a foot breaks the transmission of the signal, the unit will commence operating. When the foot is removed, the sensor will resume receiving the signal and the unit will automatically shut off.

### CROSS-REFERENCE TO RELATED APPLICATIONS

This application claims priority to U.S. Provisional Patent Application Ser. No. 60/501,129 filed on Sep. 8, 2003, incorporated herein by reference in its entirety.

### BACKGROUND OF THE INVENTION

1. Field of the Invention

The present invention relates to an improved footbath with an electronic sensor to detect a foot entering or leaving the bath and automatically switching on or off.

2. Description of Related Art

It is known in the art to employ multiple mechanical switches as well as an array of switches on an infrared remote hand piece to control the settings on the various features available in an electric footbath. The features can include, for example, heat, vibration, air and water pumps, ozone and infrared lamps. Each of the feature parameters can have a range of settings. The various settings can be powered independently or through a single common on/off switch. Either way when the appliance is on, with a number of motors operating, it is a loud, aggressively vibrating appliance that would be irritating if left running unnecessarily.

There is a need therefore, for a circuit which would automatically shut off the appliance whenever one's feet are removed from the bath and which would restart the appliance, with the previous settings intact on all the various feature parameters, when one's feet are again inserted into the bath.

### OBJECT AND SUMMARY OF THE INVENTION

It is an object of the present invention to overcome the shortcomings of the prior art mentioned above. These and other objects are achieved by the present invention described herein.

The present invention is of an automatic sensing and switching device that detects the entry of the feet, or other portion of the body, into a bath appliance and which automatically switches on and off depending on the presence of the body.

### BRIEF DESCRIPTION OF THE DRAWINGS

The present invention is more fully understood by reference to the following detailed description of an illustrative embodiment with the drawings identified below.

FIG. 1 is a schematic illustration of the preferred embodiment of the footbath with an infrared sender and receiver.

FIG. 2 is an enlargement of FIG. 1.

### DETAILED DESCRIPTION OF THE INVENTION

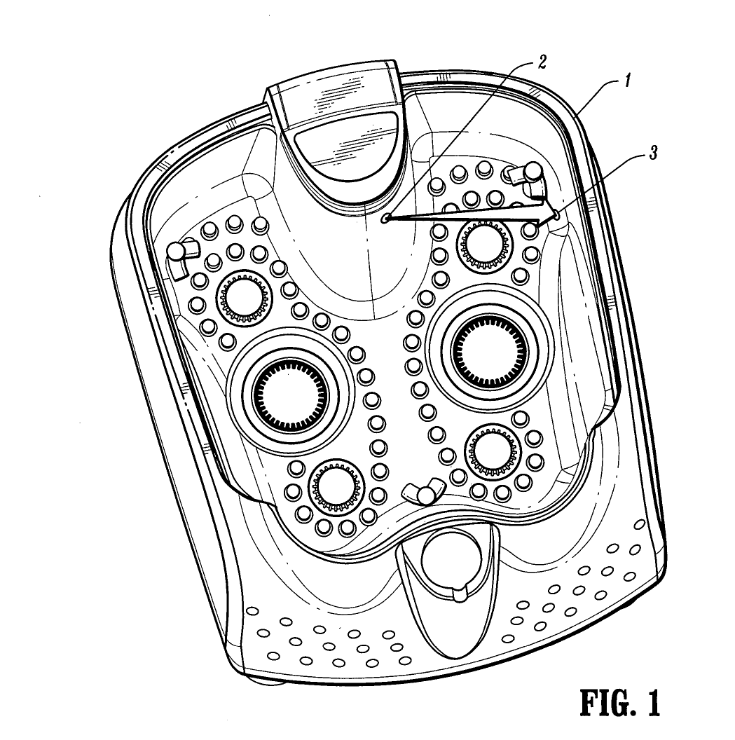

Referring to FIG. 1, the preferred embodiment of the present invention (1), a footbath with an infrared sensor, both a sender (2) and a sensor (3) to detect the presence of a foot and to automatically power the appliance on. The infrared sensor transmits a signal from the sender to the sensor, as is known to those skilled in the art. Whenever a foot is inserted into the water the unit will commence operating with whatever parameters are previously set on the various mechanical or remote switches. When the foot is removed, the sensor will once again receive the signal from the sender, and the unit will automatically shut off. Reinserting the foot will restart the appliance with the prior settings.

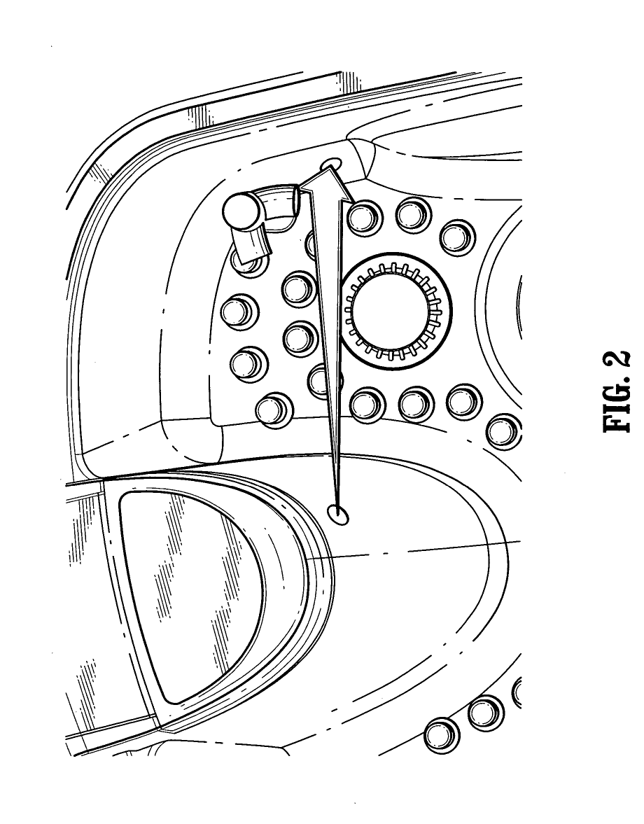

FIG. 2 is an enlarged illustration of the preferred infrared sender (2) and sensor (3). An alternative embodiment would add a second sensor on the opposite side of the tub.

While the preferred embodiment teaches an infrared sensor, with a logic that requires the foot to break the IR beam to switch the unit, it could also be designed to use the reflection of this same beam off the body, with the sender and sensor together at one position. Alternative embodiments could also employ light beams and photo eyes, as generally known to those skilled in the art, to replace the preferred IR sensor. Additionally, alternative embodiments could use capacitive switches to detect the presence of the feet, as well as mechanical switches detecting the displacement and subsequent change in water level of the tub when the feet are submerged, as available to those skilled in the art. Another alternative would be to employ a direct mechanical or pressure switch mounted under a waterproof membrane, at the bottom of the tub and under the feet.

While a preferred embodiment of the invention has been herein disclosed and described, it is understood that various modifications can be made without departing from the scope of the invention.

1. A footbath comprising:
a housing;
a reservoir within said housing for holding water;
a sensing device within said reservoir comprising a transmitter for transmitting a signal and a receiver for detecting the receipt of said signal from said transmitter; and
one or more controls adapted to operate said footbath for the duration of time that said signal from said transmitter to said receiver is interrupted by an object within said reservoir.

2. A footbath according to claim 1, wherein
said sensing device transmits infrared beams.

3. A footbath according to claim 1, wherein
said sensing device employs light beams and photo eyes.

4. A footbath according to claim 1, wherein
said transmitter and said receiver are located at the same position to transmit signals toward a user's body and receive reflected signals from said user's body.

5. A footbath comprising:
a housing;
a reservoir within said housing;
one or more controls for operating said footbath; and
a switch within said reservoir for activating said one or more controls.

6. A footbath according to claim 5, wherein
said switch is adapted to detect the change in water level when an object is submerged in said reservoir.

7. A footbath according to claim 5, wherein
said switch is mounted under a waterproof membrane at the bottom of said reservoir for activating said one or more controls when pressure is placed on said switch.
